(19) United States
(12) Patent Application Publication
(10) Pub. No.: US 2005/0127313 A1
(43) Pub. Date: Jun. 16, 2005

(54) System and method for filtering reflected infrared signals

(75) Inventor: Thomas J. Watson, Madison, AL (US)

Correspondence Address: REINHART BOERNER VAN DEUREN S.C.;ATTN: LINDA GABRIEL, DOCKET COORDINATOR, 1000 NORTH WATER STREET, SUITE 2100, MILWAUKEE, WI, 53202, US

(73) Assignee: Synapse, Inc., Huntsville, AL (US)

(21) Appl. No.: 10/045,331

(22) Filed: Oct. 23, 2001

Related U.S. Application Data
(60) Provisional application No. 60/267,441, filed on Feb. 8, 2001.
(60) Provisional application No. 60/242,898, filed on Oct. 24, 2000.

(51) Int. Cl. F16K 31/02

(52) U.S. Cl. 251/129.04; 700/282

(57) ABSTRACT

A system for preventing IR reflection ghosting in a fluid-dispensing device having a transmitter/receiver pair and control logic. The control logic interfaces with the transmitter and the receiver, activating the fluid-dispensing device when an object is present within the transmitter detection range by comparing a set predefined value with the IR value obtained. When the reflection is above the detection level, the control logic further evaluates two consecutive pulses to detect movement between said two consecutive pulses. An increase in IR value indicates movement, thereby causing the fluid-dispensing device to be activated.

### CROSS-REFERENCE TO RELATED APPLICATIONS

This application claims the benefit of U.S. Provisional Patent Application Ser. No. 60/267,441 entitled, “Remotely Managed Automatic Dispensing Apparatus and Method”, filed on Feb. 8, 2001, and U.S. Provisional Patent Application Ser. No. 60/240,898 entitled, “Remotely Managed Automatic Dispensing Apparatus and Method”, filed on Oct. 24, 2000, both of which are hereby incorporated by reference herein.

### BACKGROUND OF INVENTION

1. Field of the Invention

The present invention relates generally to the field of infrared (IR) reflection sensing, and more particularly to the accurate sensing of a reflected infrared signal that may be effected artificially due to a change in the environment of the reflection field of an infrared transmitter.

2. Technical Background

Infrared transmitter/receiver pairs are typically employed to electronically control water flow through a fluid-dispensing device such as a faucet or spicket. Generally speaking, an IR pulse is emitted from a transmitter disposed in the base of the fluid-dispensing device. The transmitter has a direction and a range such that the presence of an object within the detection range activates the flow of water from the fluid-dispensing device. In this regard, if an object is within the direction and range of the transmitter, a transmitted IR pulse is reflected from the object, and the corresponding receiver that is located in the base, detects the reflected pulse. Control logic then activates a solenoid valve turning on the water.

IR activated devices that control water flow exhibit particular problems with respect to their use on faucets. For example, a fluid dispensing device may be inaccurate in that it does not detect an object at different ranges. Different ranges are desirable to account for varying sink and faucet configurations. For example, if the detection range is set at an unvarying value, then a fluid-dispensing device having a deeper sink may be less accurate in that a user would be required to place his/her hands inconveniently close to the transmitter/receiver pair.

Frequently, water droplets inadvertently splash onto the optics (i.e., the transmitter/receiver pair). When this occurs, the direction of a light wave (pulse) emitted from the transmitter is changed by the presence of the water. The redirection of the light may cause an object normally outside of the detection range to be detected. In addition, the fluid-dispensing device may erroneously detect an object outside of the desired detection range if the object is constructed of a thermosteel or other highly reflective material. Such erroneous detection may cause the inadvertent activation of the solenoid.

Moreover, the proximity of such an object and the material from which such objects are made can contribute to inaccurate behaviors of the automated fluid-dispensing device, particularly when the fluid-dispensing device is configured to vary its detection ranges. When the direction and range of the emitted pulse is changed, then unintended objects reflect the light sensed by the receiver. Where the object is proximate and the material from which the object is made is highly reflective, the energy of the reflected pulse is augmented.

Augmentation of the reflected pulse causes hardware and control logic malfunction. Receivers characteristically have maximum operating parameters, including a maximum input power. Where a pulse that exceeds a specified maximum input value is within detection range, the receiver can become saturated. In addition, the control logic of the electronics that is configured to detect an object within a specific range performs analysis on the IR detection level.

### SUMMARY OF THE INVENTION

Generally, the present invention provides a system and method that allows for the normal operation of an IR controlled fluid-dispensing device wherein the control logic activates the solenoid when an IR detection value is received per range setting. In addition, the system and method of the present invention incorporate software filtering into the control logic such that the fluid dispensing device continues to operate when its input is affected by environmental factors.

A system for filtering reflected infrared signals in a fluid-dispensing device transmitter/receiver pair and control logic. The control logic interfaces with the transmitter and the receiver, activating the fluid-dispensing device when an object is present within the transmitter detection range by comparing a set predefined value with the IR detection value. When the reflection is above the detection level, the control logic further evaluates two consecutive pulses to detect movement within the detection range. An increase in IR detection value indicates movement, thereby causing activation of the fluid-dispensing device.

The present invention can also be viewed as providing a method for filtering reflected infrared signals in a fluid-dispensing device. The following steps can broadly conceptualize the method: Comparing an IR detection value to an activation threshold: detecting motion within a detection range; and controlling a fluid-dispensing device based on said comparing and detecting steps:

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the invention. Furthermore, like reference numerals designate corresponding parts throughout the several views.

FIG. 1 is a block diagram illustrating the IR apparatus and method of the present invention.

FIG. 2 is a block diagram illustrating a more detailed view of the IR apparatus depicted in FIG. 1.

FIG. 3 is a flowchart illustrating generally the architecture and functionality of the IR apparatus depicted in FIG. 1.

FIG. 4A-4F is a flowchart illustrating more specifically the functionality of the motion detection process described in flowchart in FIG. 3.

### DETAILED DESCRIPTION OF THE PREFERRED EMBODIMENTS

In general, the present invention provides an IR apparatus and method for filtering an IR reflection signal that may render the optics of an automatically activated fluid dispensing device inoperable. More specifically, an IR apparatus and method, in accordance with the present invention, determines that water accumulation on the sink basin or on the optics is affecting the automatic water activation function of the fluid dispensing device. During a normal operation cycle, an IR pulse is periodically emitted (e.g., every 250 milliseconds). If hands are not within the detection range, then the IR radiation received by the IR apparatus is preferably below an activation threshold. The pulse has a maximum range that includes the sink basin. However, if hands are within the detection range, the reflection of the pulse from the user's hands increases the energy in the pulse reflection that is detected by the IR apparatus. When the IR radiation detected by the IR apparatus exceeds the activation threshold, the solenoid valve of the device is activated as a result of the increase creating water flow.

Initially, the IR apparatus is calibrated (i.e., the activation threshold is determined) using an ambient reading of the IR energy present in the surrounding environment and an ambient reflection reading without an object in the desired detection range. In addition, the device is calibrated using a “normal” activation threshold that is indicative of an object in the range of the optics. Activation thresholds vary according to varying range setting, and activation thresholds are determined by the amount of energy that a receiving device would detect if an object were present within the detection range according to the range setting. The greater the detection range, the lesser a radiation detection would be required to activate the fluid-dispensing device. An increase in the ambient IR level above the activation threshold then causes the solenoid valve activation. As the device continues normal operation, it is automatically dynamically re-calibrated in order to account for changes in the ambient IR and the ambient reflection IR.

As the surrounding IR increases and decreases according to various environmental changes, the activation threshold on which the system determines if a user's hands are present in the optical range changes accordingly. Inherently, in the fluid-dispensing device environment, water is splashed and remains until it evaporates or drips off the sink basin or the optics.

The presence of the water on the sink basin or on the optics can cause a faulty IR reflection by increasing the energy of the reflected pulse above the activation threshold. An increase in energy that exceeds the activation threshold may cause the water flow to either remain on or not come back on when a user's hands come within range. As such, the presence of a user's hands in the range of the optics will be unable to cause the solenoid valve to be activated, causing the device to be inoperable.

The present system and method allows the detection of a user's hand's employing a set value during normal operation. However, if a reflected pulse that far exceeds detection limit inundates the receiver, then the present system and method allows the fluid-dispensing device to continue normal operation.

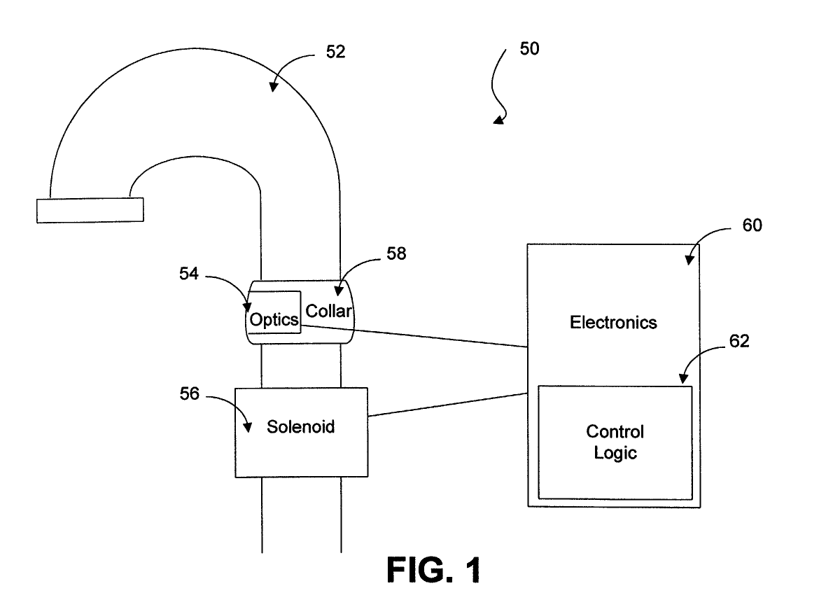

The system and method of the present invention is now discussed with reference to FIG. 1. An automatically activated fluid dispensing arrangement is shown in FIG. 1 and is designated generally throughout as reference numeral 50. The arrangement includes generally a water faucet 52 having a collar 58 with optics 54.

The solenoid 56 provides the closing mechanism that when activated and deactivated controls the water flow of the faucet 52. The optics 54 include a transmitting device and a receiving device that provide for the detection of an object within the transmitting and receiving range of the transmitting and receiving devices. The optics 54 and the solenoid 56 are connected to an electronics box 60 that includes control logic 62 for controlling the operation of the fluid-dispensing device 52. More particularly, the control logic 62 controls the solenoid 56 in response to an input of the optics 54. The control logic 62 may be implemented in hardware, software, or a combination thereof.

With reference to FIG. 1, during normal operation, the optics 54 transmits an IR pulse. When an object is within the detection range, it creates a reflection that is detected by the optics 54. In a preferred embodiment, the control logic 62 of the electronics 60 initiates a pulse cycle every 250 milliseconds, although other cycles may be employed in other embodiments. Dynamic calibration is preferably performed each pulse cycle to determine an ambient IR value and a reflection IR value.

After transmitting an IR pulse, the optics 54 receives a reflection of the pulse from an object that may be within or outside of the detection range. Control logic 62 of the electronics 60 determines whether an object is within the detection range by analysis of the reflection value received by the optics 54. Generally speaking, the control logic 62 determines whether an object is within the detection range by comparing the IR reflection value received by the optics 54 with an activation threshold. The base IR value is preferably set at a level that accounts for ambient IR. In addition, the control logic 62 uses a pre-programmed static value that represents a normal increase in IR energy that indicates the presence of movement of an object in the detection range.

Under normal conditions, the control logic 62 compares the IR sample value with the ambient level readings of the IR and concludes from the comparison whether an object is within the detection range. However, if water particles are present on the optics 54 or on the sink basin of the preferred embodiment, then the ambient and dynamic IR level readings can be skewed. Therefore, the preferred embodiment of the present invention allows for the normal operations under these conditions. For example, if during the pulse cycle, the IR level is above detection level, the preferred embodiment process continues to provide fluid-dispensing activation when there is an increase in IR and continues to deactivate despite a high-energy IR sample reading.

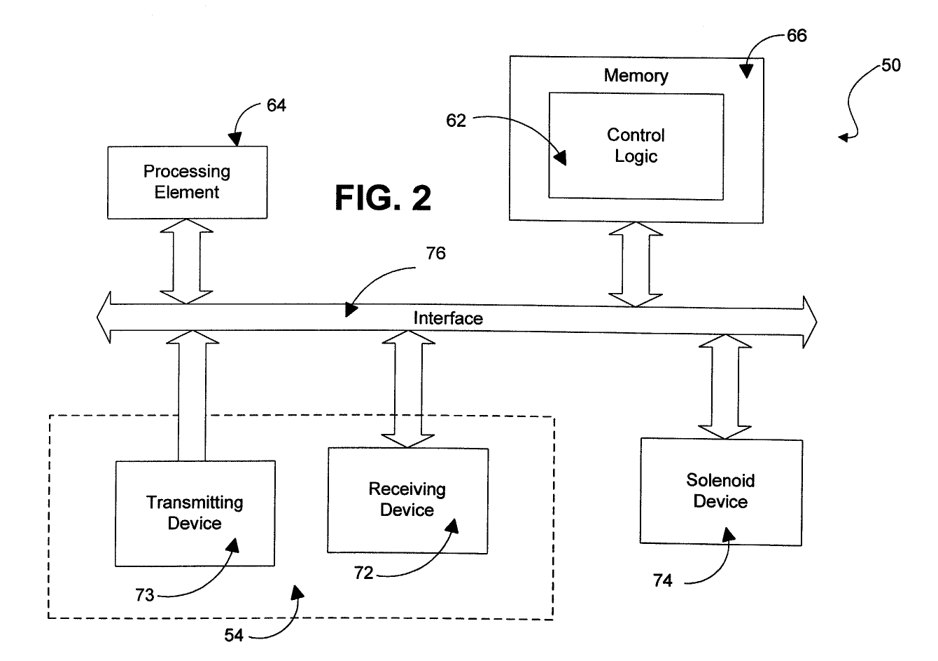

A preferred embodiment of the present invention is illustrated by way of example in FIG. 2. A pulse is emitted from the transmitting device 73 of optics 54. When an object is present within the detection range, the pulse is reflected, and the receiving device 72 detects the reflected signal. In a preferred embodiment, the control logic 62 is implemented in software and stored in memory 66. The control logic 62 initiates the pulse cycle that causes the pulse to be emitted from the transmitting device 73. In addition, the control logic 62 determines from the reflection detected by the receiving device 72 whether sufficient energy levels are detected to justify activating the solenoid 74. Note that the control logic 62 can be implemented in software, hardware, or a combination thereof. In the preferred embodiment, as illustrated by way of example in FIG. 2, the control logic 62, along with its associated methodology, is implemented in software and stored in memory 66.

Further note that the control logic 62, when implemented in software can be stored and transported on any computer readable medium for use by or in connection with an instruction execution system. An instruction execution system can include but is not limited to devices such as a computer-based system, processor-containing system, or other system that can fetch the instructions from the instruction execution system and execute the instructions.

In the context of this document, a “computer-readable medium” can be any means that can contain, store, communicate, propagate, or transport the program for use by or in connection with the instruction execution system. The computer-readable medium can be, for example but not limited to, an electronic, magnetic, optical, electromagnetic, infrared or semi-conductor system or propagation medium. More specific examples (a non-exhaustive list enclosed) of the computer-readable medium would include the following: An electrical connection having one or more wires, a portable computer diskette and random access memory (RAM), a read-only memory (ROM), an erasable programmable read-only memory (EPROM or flash memory), an optical fiber, and a portable compact disc read-only memory (CDROM).

Finally, note that the computer-readable medium can be paper or another suitable medium upon which the program can be printed. The program can be electronically captured, via for instance optical scanning of the paper or other medium, then compiled, interpreted or otherwise processed in a suitable manner if necessary and then stored in memory. As an example, the control logic 62 may be magnetically stored and transported on a conventional portable computer diskette.

In addition, the preferred embodiment of the system of the present invention 50 of FIG. 2 comprises one or more processing elements 64, such as a digital signal processor (DSP) or a central processing unit (CPU). For example, the processing element can be any element that can communicate to and drive the other elements within the apparatus 50 via a local interface 76, which can include one or more buses. Furthermore, a transmitting device 73, for example, an infrared transmitter. can be used to transmit a pulse, and a receiver device 72, for example, an infrared receiver, can be used to sense a reflective signal transmitted by the transmitting device 73. The solenoid device 74 can be connected to the local interface 76 to receive activation or deactivation signals from the control logic 62 to activate or deactivate.

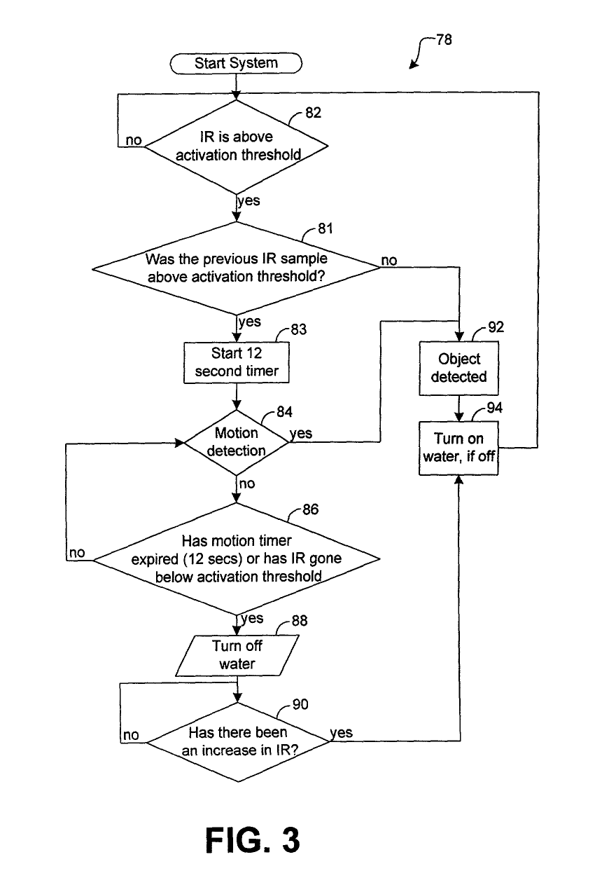

FIG. 3 describes generally the function of the system for filtering reflected infrared signals and the process is generally referred to throughout by reference numeral 78. Throughout process 78, the IR transmitting device 73 (FIG. 2) periodically emits an IR pulse, and the receiving device 72 (FIG. 2) periodically detects IR radiation levels. For each detection the IR receiving device 72 (FIG. 2) outputs a value, hereinafter referred to as “IR detection value”, indicative of the level of detected radiation. Generally the IR detection value is proportionately higher for higher levels of detected radiation.

In block 82, the control logic 62 (FIG. 2) in process 78 compares the most recent IR detection value to the activation threshold. If the IR detection value falls below the activation threshold, the process 78 repeats block 82 for the next IR detection value. However, if the IR detection value exceeds the activation threshold, then in decision step 81, the process 78 evaluates the previous IR detection value, determining if the current IR detection value indicates that the current reading represents the first time the IR detection value has gone above the activation threshold. If the previous IR detection value was not above the activation threshold, then in processing step 92 it is indicated that an object is detected, and the solenoid valve is pulsed in processing step 94. The control logic then again evaluates the current IR detection value in decision step 82.

If the evaluation in decision step 81 indicates that consecutive IR detection values have exceeded the activation threshold, then the process 78 begins tracking time in process step 83. In decision step 84, the control logic 62 (FIG. 2) checks for motion. If motion is detected, then it is determined that an object is present in Processing Step 92, and the solenoid valve is activated turning the water on, if not on already, in Processing Step 94. The control logic 62 (FIG. 2) then retrieves yet another IR reading from the IR receiving device 72 in process step 82.

If, on the other hand, motion is not detected over a set interval in decision step 84, then the process 78 determines if a predetermined amount of time (e.g., 12 seconds) has elapsed since process step 83. The predetermined amount of time is preferably set such that a motion detection in process step 84 is likely to occur before the expiration of the predetermined amount of time if a user is attempting to wash his hands at the fluid-dispensing device 52 (FIG. 1). Thus if the predetermined amount of time expires without a motion detection or the IR detection value goes below the activation threshold as queried in decision symbol 86, it can be assumed that the IR detection value exceeded the activation threshold due to the presence of water on the transmitting device 73 or the receiving device 72, water is present on the sink rim, or other debris is causing a high energy reflection to the receiving device. Further, it can be assumed that if the IR detection value goes below the activation threshold while the control logic 62 (FIG. 2) is detecting motion, then the water on the optics problem has remedied itself. Moreover, if the predetermined amount of time expires without a motion detection in decision step 84 or if the IR detection value falls below the activation threshold, the control logic 62 activates the solenoid in processing step 88 such that the water is prevented from flowing from device 52 (FIG. 1).

The control logic 62 as indicated by processing step 90 checks each IR detection value output from the IR receiving device 72 (FIG. 2) until one of the IR detection values exceeds a previous IR detection value. Such an increase in consecutive IR detection values likely indicates that an object has come within the detection range of the device 52 (FIG. 1). When an increase is detected, then the control logic 62 proceeds to block 94 thereby enabling the water to be turned on in the course of implementing process 78. As a result, the device 52 remains operable even if the presence of water on the receiving device 72 and/or transmitting device 73 is skewing the comparisons being performed in block 82.

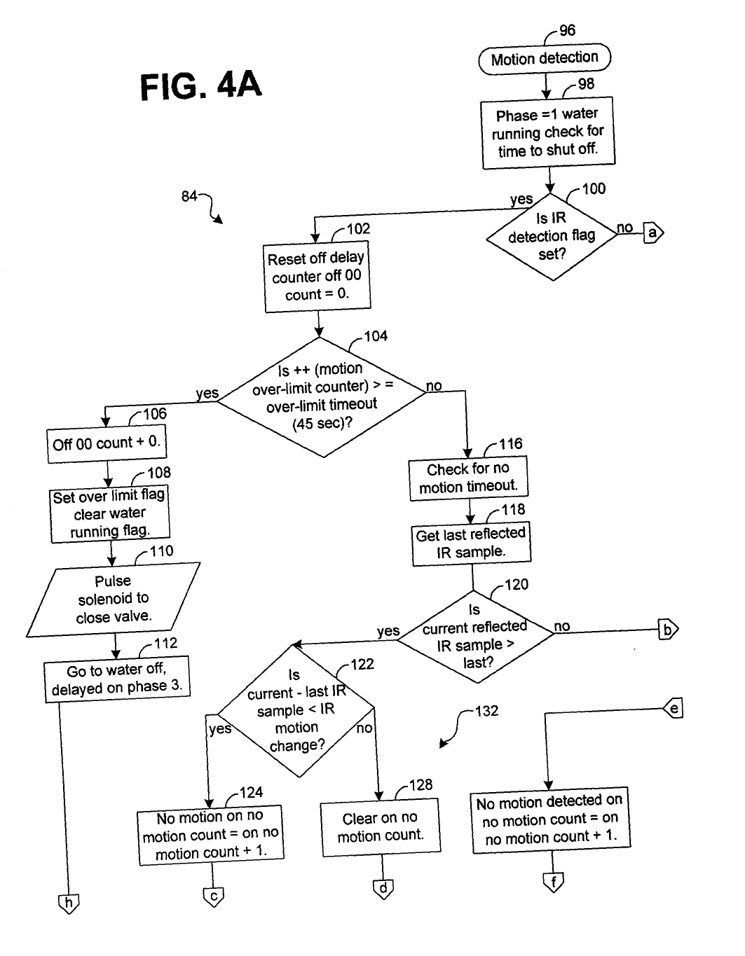

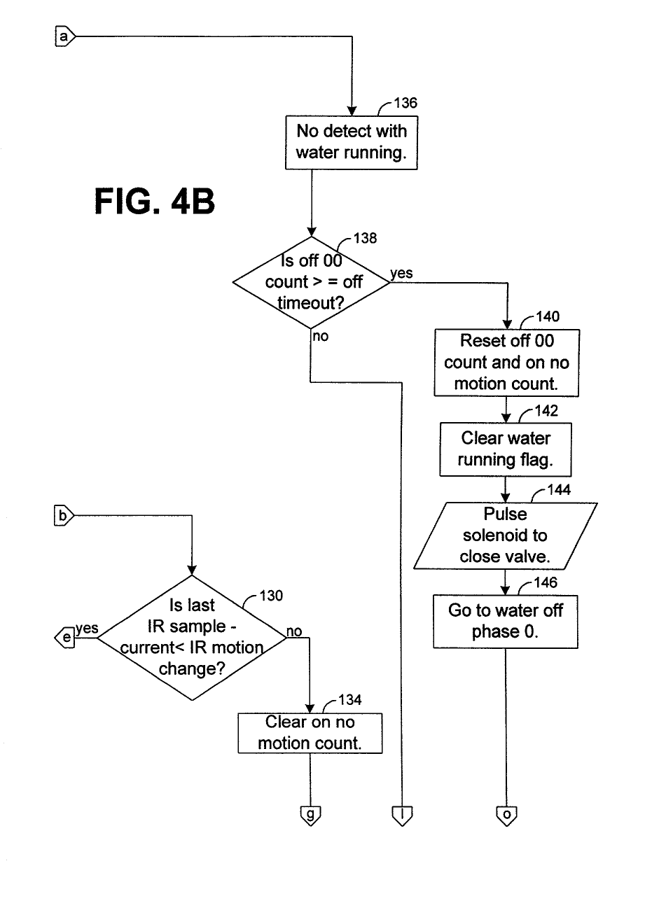

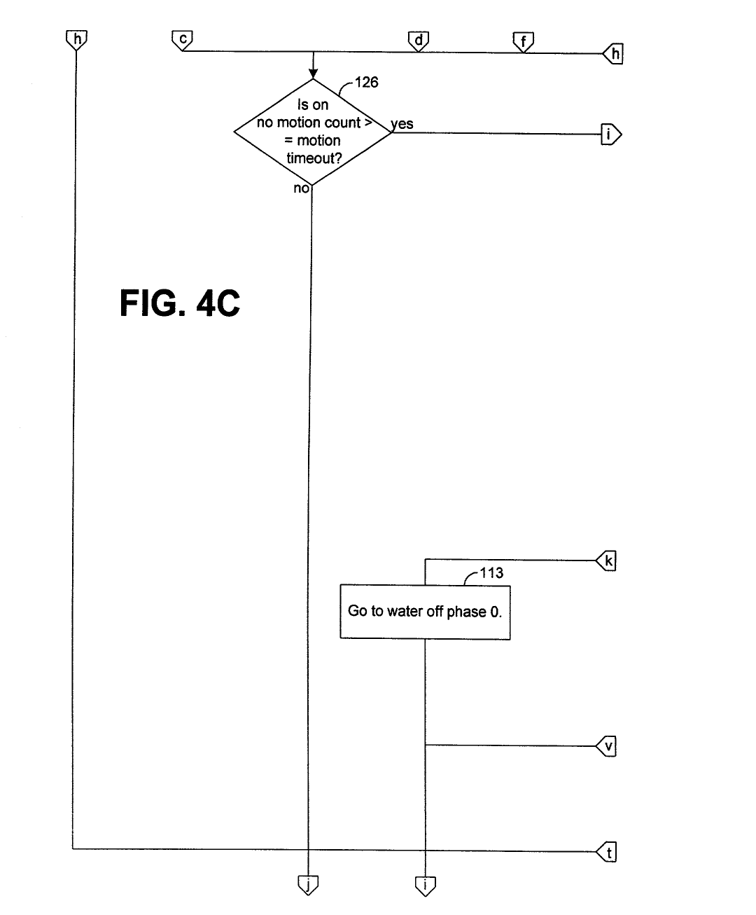

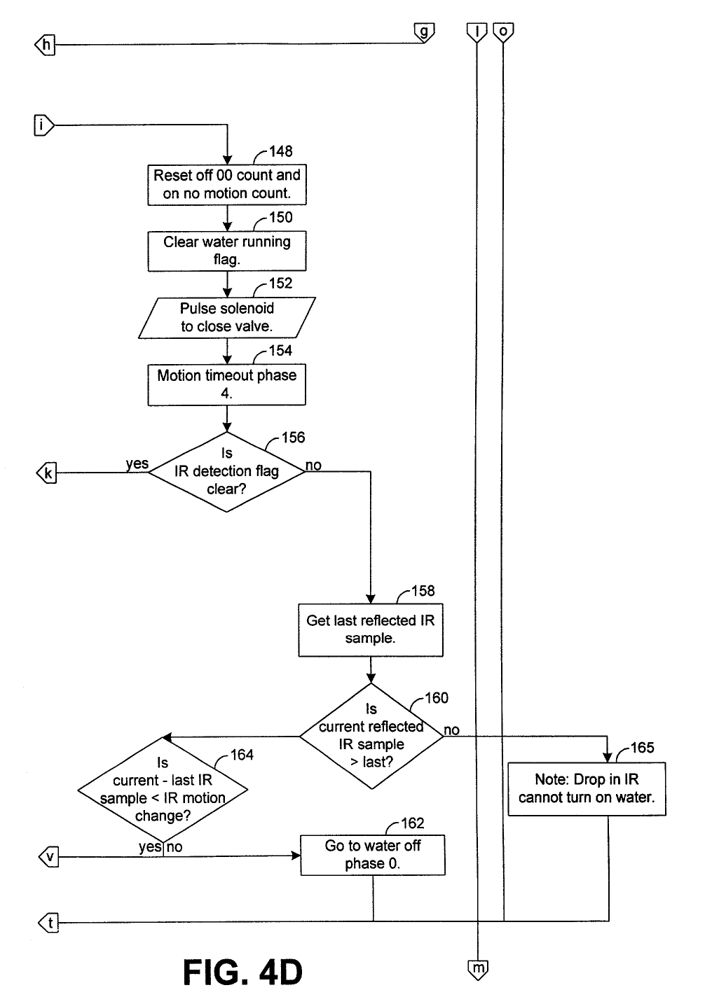

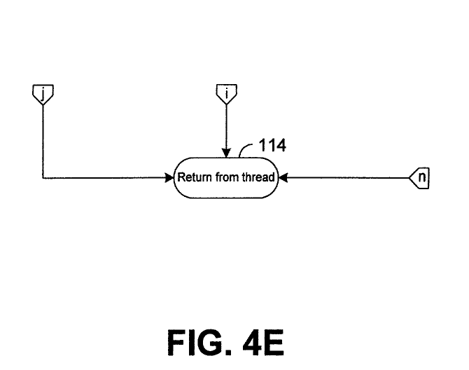

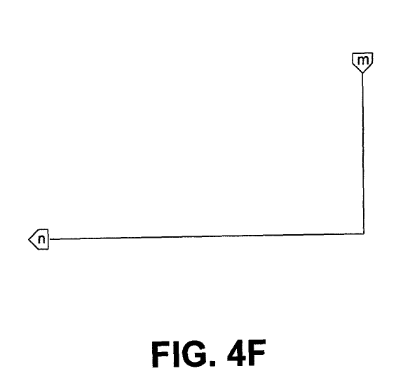

The process described in FIG. 3 is more specifically detailed in FIGS. 4A-4F. The Motion Detection Thread 84 begins at processing symbol 96. As indicated by processing symbol 98, Phase 1 of the Motion Detection Thread 84 is executed when the device is currently dispensing fluid. The decision symbol 100 queries an IR Detection Flag to determine if an object was detected during the current pulse cycle. If an object was detected the counter for water flow off delay timeout is set to zero (0) as indicated in processing symbol 102.

The decision symbol 104 determines whether the water has been running for more than forty-five (45) seconds, which is a maximum water running timeout limit. If the water has been running more than 45 seconds, then an over limit flag is set indicating that the water running limit is reached, and the flag indicating that the water is running is reset or cleared as indicated by processing symbol 108. The solenoid is pulsed to close the valve in processing symbol 110.

If the water has not been running for more than forty-five seconds in processing symbol 104, then in processing symbol 116 the No Motion Timeout is checked, and the previous reflected IR sample is retrieved in 118. The previous reflected sample obtained is compared to the current IR sample in decision symbol 120. If the current sample exceeds the previous sample, then the last IR sample is subtracted from the current IR sample. If the difference is less than a predetermined value a motion threshold that indicates motion between the previous and current IR samples in decision symbol 122, then a flag indicating that no motion was detected is incremented as indicated in processing symbol 124. If the difference is not less that the predetermined value, then the counter indicating consecutive non-motion cycles is reset or cleared as indicated in processing symbol 128.

With reference to FIG. 4C, the counter indicating that the water is on but no motion has been detected for a predetermined period is evaluated in decision symbol 126. If the value is greater than a timeout value, the counter indicating that the fluid-dispensing device just shut off and the counter indicating that the faucet is on but no motion has been detected are reset in processing step 148. The water running flag is cleared in processing step 150, and a separate process as indicated by the process call 152 is initiated that pulses the solenoid to close the valve.

If at the decision symbol 100 in FIG. 4A, it is determined that the IR Detection Flag is not set, then there has been no motion detected and fluid is currently being dispensed from the device. With respect to FIG. 4B, whether the duration of the water flow from the fluid-dispensing device has exceeded an off timeout threshold is determined from the query in decision symbol 138. When it has not exceeded the timeout, then the Thread returns in terminating symbol 114.

When the water is currently running and the IR value currently being evaluated indicates no detection, the counter indicating the duration that the water has been on is evaluated in decision symbol 138. If the water has been running longer than the timeout value, then the counter indicating duration that the water has been activated without detection and the counter indicating that the faucet is on but no motion is detected are reset in processing symbol 140. The solenoid is then pulsed to close the valve in the predefined process as indicated in 144. If the IR Detection Flag is clear (no detection of a user's hands) by the query indicated in decision symbol 156 (FIG. 4D), then the thread returns to the water off phase zero (0) as indicated in processing symbol 113 (FIG. 4C).

When a previous cycle ends with a deactivation of the water flow due to exceeding a timeout value, then the next cycle enters the Motion Detection Thread at Phase four at processing symbol 154 in FIG. 4D. If the IR Detection Flag indicates that a user's hands were detected in decision symbol 156, then the previous reflected IR sample is retrieved in processing symbol 158. The current reflected IR sample is compared to the previous reflected IR sample in decision symbol 160. If the current reflected sample is not greater than the previous sample, then the Motion Detection thread returns at termination symbol 114 (FIG. 4E). If the current sample is greater than the previous sample in decision symbol 160, then the difference in the current IR sample and the previous IR sample is examined to determine if it exceeds the IR motion change threshold in decision symbol 164. If it does not meet or exceed the threshold, then the water remains off, and the Motion Detection Thread continues to be active in phase four as indicated in processing symbol 162 and returns in terminating symbol 114. If the evaluation in decision symbol 164 indicates a motion change, then the motion detection Thread terminates and the water is turned on. In other words, a drop in IR will not turn on the water.

1. A system for processing reflected infrared signals which are used to control the flow of water from a water faucet or the like, said system comprising:
an IR transmitting device for transmitting an IR signal toward a location proximate the place from which water may be dispensed from the faucet;
an IR receiving device for receiving a reflected IR signal from a detection range proximate the location from which water may be dispensed from the faucet, said IR receiving device providing an output signal, said output; signal being proportional to the magnitude of the reflected IR signal; and
control logic configured to receive said output signal from said IR receiving device, wherein said control logic compares said output signal with an activation threshold to determine the presence of an object within said detection range, said control logic further configured to detect the occurrence of motion within said detection range, said control logic providing a water control signal which may be used to control the flow of water through the faucet based upon the results of the determination of the presence of an object within the detection range and the occurrence of motion within said detection range.

2. A system defined in claim 1, said system further comprising a fluid dispensing device, water control valve wherein said control logic is configured to activate the water control valve when either the presence of an object within the detection range is determined or the occurrence of motion within said detection range is determined.

3. A system as defined in claim 2, wherein said control logic is further configured to execute a timer for a predetermined time interval when said water control valve is activated, and to deactivate said water control valve when timer expires or when the presence of an object within the detection range is no longer determined.

4. A system as defined in claim 3, wherein said control logic is configured to detect an increase in said output signal from said IR receiving device and activate the water control valve in response thereto.

5. A system as defined in claim 1, wherein said IR transmitting device periodically emits IR pulses, and wherein said IR receiving device is positioned to detect reflections of said IR pulses from said IR transmitting device.

6. A system as defined in claim 1, wherein said control logic detects motion by calculating the difference between consecutive samples of said output signal from said IR receiving device and comparing said difference to said activation threshold.

7. A method for processing reflected infrared signals which are used to control the flow of water from a water faucet or the like, said method comprising the steps of:
transmitting an IR signal from an IR transmitting device toward a location proximate the place from which water may be dispensed from the faucet;
receiving a reflected IR signal with an IR receiving device from a detection range proximate the place from which water may be dispensed from the faucet, said IR receiving device providing an output signal which is proportional to the magnitude of the reflected IR signal;
comparing said output signal from said IR receiving device to an activation threshold to determine the presence of an object within said detection range;
detecting the occurrence of motion within said detection range; and
controlling the flow of water through the faucet based upon the results of said comparing and detecting steps.

8. (canceled)

9. A method as defined in claim 7, wherein said controlling step comprises activating the the water control valve when either the presence of an object within the detection range is determined or the occurrence of motion within said detection range is determined.

10. A method as defined in claim 9, said method further comprising the steps of:
setting a timer for a predetermined interval upon activation of the water control valve;
detecting the presence or absence of motion during said predetermined interval; and
deactivating the water control valve when said predetermined time interval expires or when the the water control valve when either the presence of an object within the detection range is determined or the occurrence of motion within said detection range is determined.

11. A method as defined in claim 10, said method further comprising the steps of:
detecting the presence or absence of an increase in said output signal from said IR receiving device; and
activating the the water control valve in response to an increase in said output signal from said IR receiving device.
